(19) United States
(12) Patent Application Publication
(10) Pub. No.: US 2008/0028902 A1
(43) Pub. Date: Feb. 7, 2008

(54) Dual roll, variable sheet-length, perforation system

(75) Inventors: James Leo Baggot, Menasha, WI (US); Frank Stephen Hada, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/498,864

(22) Filed: Aug. 3, 2006

(51) Int. Cl. B23D 25/12; B26D 1/56

(52) U.S. Cl. 83/13; 83/345; 83/76

(57) ABSTRACT

A method and apparatus (20) for intermittently cutting a moving target web (26) includes rotating a knife roll (32) having at least one knife member (44) to provide an operative knife-member speed, and rotating an anvil roll (34) having at least one anvil member (46) to provide an operative anvil-member speed. The knife roll and anvil roll have been positioned to provide an operative nip region (30) therebetween, and a substantially continuous target web (26) has been moved at a selected web speed through the nip region. A rotational positioning of the knife member has been coordinated with a rotational positioning of its cooperating anvil member to provide an operative, cutting engagement between the knife member and its cooperating anvil member, thereby cutting the moving web at cut locations which are intermittently spaced along a machine-direction (22) of the target web.

### FIELD OF THE INVENTION

The present invention relates to a system for selectively cutting a moving web. More particularly, the present invention pertains to a system for selectively perforating a moving target web, such as a substantially continuous target web. The target web can be substantially flat and may include a film material, fabric material, non-woven material, paper material, tissue or towel material.

### BACKGROUND OF THE INVENTION

Methods and apparatuses intended to cut or produce lines of perforations in a moving target web are well known in the art. Conventional processes and machines have included a rotary knife roll and a stationary anvil. The rotary knife rolls have included removable and replaceable knife blades, which have extended generally along the axial direction of the knife roll, and have been distributed along the circumference of the knife roll with regular or irregular, intermittent spacing. In addition, the knife blades have been placed at an angle relative to the rotational axis of the knife roll. The placing of the blades on the roll at an angle has helped to reduce the impact loads generated during the cutting of the target web. In particular arrangements, it has also been necessary to skew the axis of rotation of the knife roll relative to the direction of the web movement past the knife roll. The amount of skewing has been suitably adjusted to obtain substantially straight cut along transverse cross-direction of the target web. Conventional techniques and devices are well known in the art, and suitable anvils and rotary knife rolls are available from commercial vendors.

Ordinary methods and apparatuses, however, have not provided desired combinations of efficiency and versatility, particularly when the cutting processes are operated with high web speeds. When conventional processes and machines have been arranged to cut a target web that is moving at high speeds past the anvil, the impact forces between the blade and the anvil have caused high rates of wear requiring a frequent changing of the knife and anvil blades. To reduce wear, the amount of interference between the knife and anvil blades has been set to relatively small values. The small values of interference help to reduce wear, but can lead to areas of missing perforations in the web, due to vibrations in the components of the equipment and variations in the set up of the equipment. A poor quality in the perforations is not only poorly received by the final customer using the product, but can also lead to a poor operation of the manufacturing process. For example, an individual perforation line is typically used as the separation line between rolls of finished product; and poor quality, perforation line can disrupt the reliability and quality of the separation process. It has also been cumbersome and time-consuming to reconfigure conventional systems to produce different spacings between the desired cut locations along the lengthwise movement direction of the target web. As a result, there has been a continued need for improved cutting systems that provide improved reliability and versatility, along with an improved and more reliable definition of the perforation line.

### BRIEF DESCRIPTION OF THE INVENTION

Generally stated, the present invention provides a method for intermittently cutting a moving target web, which includes rotating a knife roll having at least one knife member to provide an operative knife-member speed, and rotating an anvil roll having at least one anvil member to provide an operative anvil-member speed. The knife roll and anvil roll have been positioned to provide an operative nip region therebetween, and a substantially continuous target web has been moved at a web speed through the nip region. A rotational positioning of the knife member has been coordinated with a rotational positioning of a cooperating anvil member to provide an operative, cutting engagement between the knife member and its cooperating anvil member, thereby cutting the moving web at cut locations which are intermittently spaced along a machine-direction of the target web.

In another aspect, an apparatus for intermittently cutting a moving target web includes a knife roll which has at least one knife member and is rotatable to provide an operative knife-member speed, and an anvil roll which has at least one anvil member and is rotatable to provide an operative anvil-member speed. The anvil roll is positioned to provide an operative nip region between the anvil roll and the knife roll, and a transport system is configured to move a substantially continuous target web at a web speed through the nip region. A control system coordinates a rotational positioning of the knife member with a rotational positioning of its cooperating anvil member to provide an operative, cutting engagement between the knife member and its cooperating anvil member to thereby cut the moving web at intermittent locations spaced along a longitudinal, machine-direction of the web.

By incorporating its various aspects and features, the method and apparatus can provide better control of the relative speeds at which the cooperating anvil members and knife members contact or otherwise engage each other in the nip region between the knife and anvil rolls. In desired arrangements, the method and apparatus can help provide selected speed differences or differentials between the moving web, the moving knife member and its cooperating, moving anvil member in the nip region to help provide a more reliable and more consistent bonding, perforating or other cutting operation. Impact loads between the knife member and its cooperating anvil member can be more efficiently and effectively controlled to provide a method and apparatus that can require less maintenance and provide greater reliability. Where the method and apparatus incorporates multiple sets or groups of cooperating knife members and anvil members, the operation of the method and apparatus can be switched between the different sets of cooperating knife and anvil members by operatively adjusting the phasing between the knife and anvil rolls.

### BRIEF DESCRIPTION OF THE DRAWINGS

The invention will be better understood by reference to the following description of the invention taken in conjunction with the accompanying drawings, wherein:

FIG. 1 representatively shows a schematic, side-elevational view of the method and apparatus for cutting a moving target web.

FIG. 2 representatively shows a schematic, perspective view of the method and apparatus for cutting a moving target web.

FIG. 3 representatively shows a schematic, end view of the method and apparatus for cutting a moving target web.

FIG. 3A representatively shows a schematic, end view of the method and apparatus for cutting a moving target web, in which the anvil roll has been removed.

FIG. 4 representatively shows a schematic, plan view of a moving target web after it has been processed and cut at appointed locations.

FIG. 5 shows a schematic, plan view of a representative portion of a circumference of an outer periphery of a knife roll where the outer periphery of the knife roll has been unrolled to a substantially planar, flat-out condition.

FIG. 5A representatively shows a schematic, plan view of a representative portion of a circumference of an outer periphery of an anvil roll where the outer periphery of the anvil roll has been unrolled to a substantially planar, flat-out condition.

FIG. 6 representatively shows a schematic view of a knife-member mounted on its respective knife roll.

FIG. 7 representatively shows an enlarged, schematic, cross-sectional side view of a portion of a knife roll and a portion of an anvil roll as they cooperatively engage in the nip region therebetween.

### DETAILED DESCRIPTION OF THE INVENTION

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

By the terms “particle,” “particles,” “particulate,” “particulates” and the like, it is meant that the material is generally in the form of discrete units. The units can comprise granules, powders, spheres, pulverized materials or the like, as well as combinations thereof. The particles can have any desired shape such as, for example, cubic, rod-like, polyhedral, spherical or semi-spherical, rounded or semi-rounded, angular, irregular, etc. Shapes having a large greatest dimension/smallest dimension ratio, like needles, flakes and fibers, are also contemplated for inclusion herein. The terms “particle” or “particulate” may also include an agglomeration comprising more than one individual particle, particulate or the like. Additionally, a particle, particulate or any desired agglomeration thereof may be composed of more than one type of material.

As used herein, the term “nonwoven” refers to a fabric web that has a structure of individual fibers or filaments which are interlaid, but not in an identifiable repeating manner.

As used herein, the terms “spunbond” or “spunbonded fiber” refer to fibers which are formed by extruding filaments of molten thermoplastic material from a plurality of fine, usually circular, capillaries of a spinneret, and then rapidly reducing the diameter of the extruded filaments.

As used herein, the phrase “meltblown fibers” refers to fibers formed by extruding a molten thermoplastic material through a plurality of fine, usually circular, die capillaries as molten threads or filaments into a high velocity, usually heated, gas (e.g., air) stream which attenuates the filaments of molten thermoplastic material to reduce their diameter. Thereafter, the meltblown fibers are carried by the high velocity gas stream and are deposited on a collecting surface to form a web of randomly disbursed meltblown fibers.

“Coform” as used herein is intended to describe a blend of meltblown fibers and cellulose fibers that is formed by air forming a meltblown polymer material while simultaneously blowing air-suspended cellulose fibers into the stream of meltblown fibers. The meltblown fibers containing wood fibers are collected on a forming surface, such as provided by a foraminous belt. The forming surface may include a gas-pervious material, such as spunbonded fabric material, that has been placed onto the forming surface.

As used herein, the phrase “cellulosic web” refers to a web which includes a major portion of cellulosic fibers. The web may be airlaid, wetlaid or a combination thereof. The cellulosic web may, for example, be employed to produce facial tissue, bath tissue, wipes, toweling, mats, personal care articles or the like.

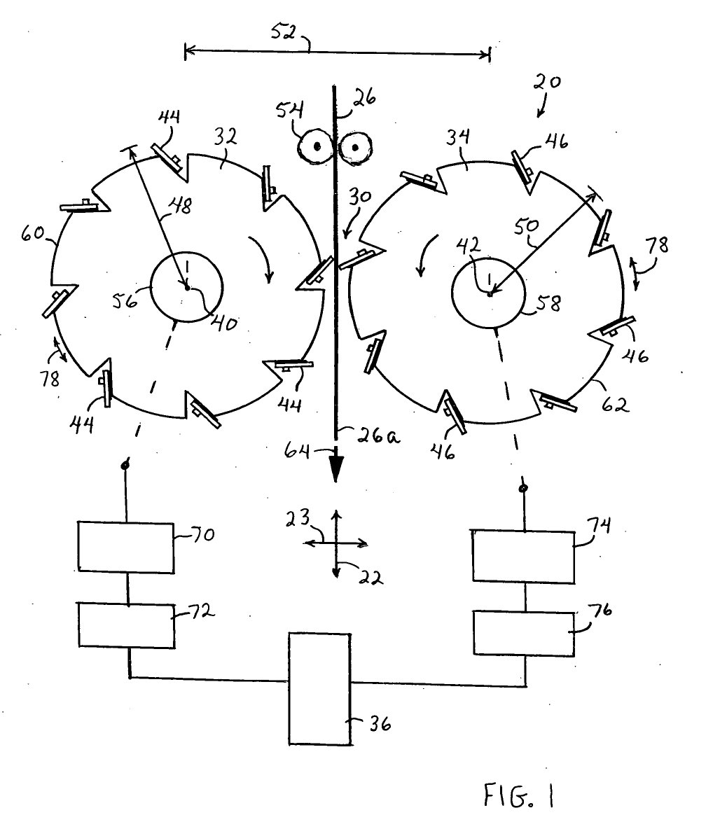

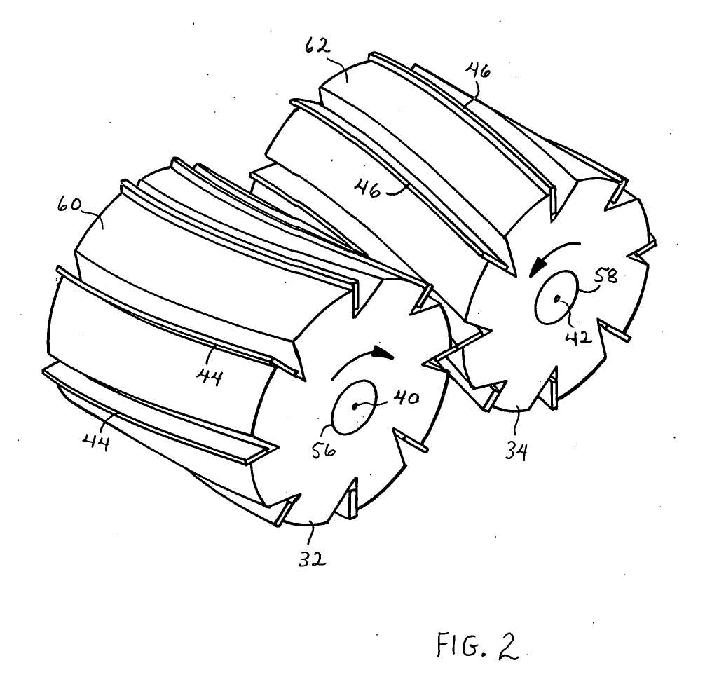

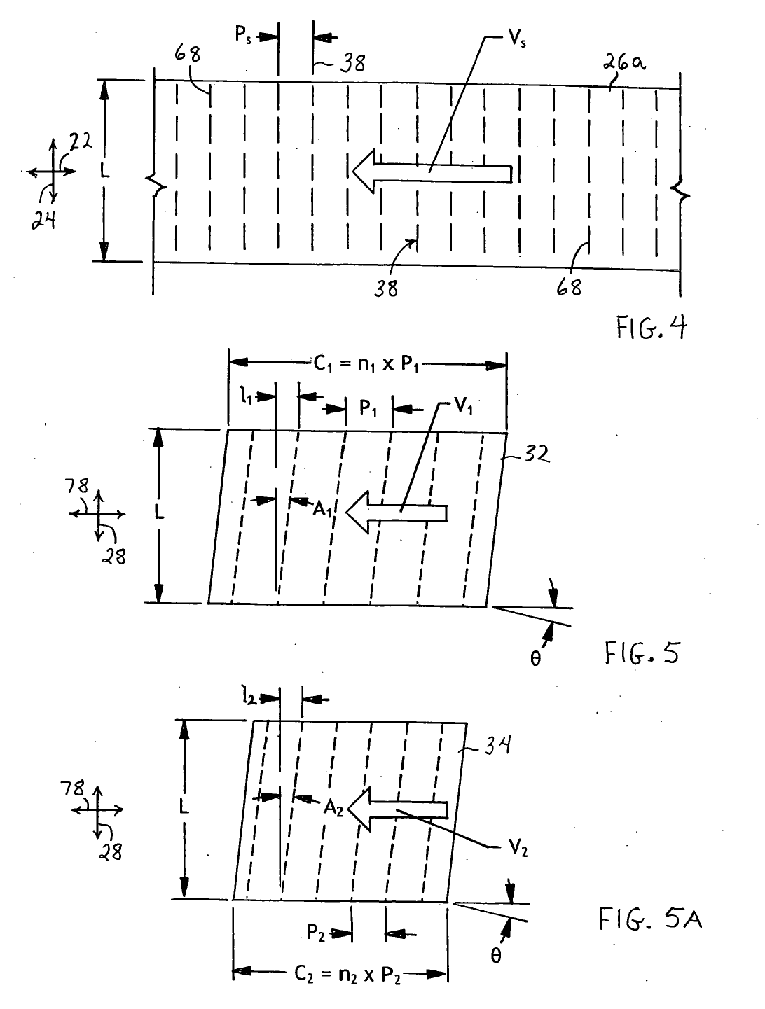

With reference to FIGS. 1 through 7, the method and apparatus 20 can have a lengthwise, machine-direction 22 which extends longitudinally, a lateral cross-direction 24 (e.g. FIG. 4) which extends transversely, and an appointed z-direction 23. For the purposes of the present disclosure, the machine-direction 22 is the direction along which a particular component or material is transported length-wise along and through a particular, local position of the apparatus and method. The cross-direction 24 is aligned perpendicular to the local machine-direction 22 along the local plane of the material targeted for work, and can lie generally parallel to the local horizontal. The z-direction is aligned substantially perpendicular to both the machine-direction 22 and the cross-direction 24, and extends generally along a depth-wise, thickness dimension of the appointed material targeted for work.

A method which can intermittently produce lines of bonds or perforations, or can otherwise intermittently cut a moving target web 26 includes rotating a knife roll 32 having at least one knife member 44 to provide an operative knife-member speed, and rotating an anvil roll 34 having at least one anvil member 46 to provide an operative anvil-member speed. The knife roll and anvil roll have been positioned to provide an operative nip region 30 therebetween, and a substantially continuous target web 26 has been moved at a selected web speed through the nip region. A rotational positioning of the knife member has been coordinated with a rotational positioning of its cooperating anvil member to provide an operative, cutting engagement between the knife member and its cooperating anvil member, thereby cutting the moving web at cut locations which are intermittently spaced along a machine-direction 22 of the target web. Additionally, a speed of the knife member can be coordinated with a speed of its cooperating anvil member to help provide the operative, cutting engagement between the knife member and its cooperating anvil member.

An apparatus 20 which can intermittently produce lines of bonds or perforations, or can otherwise intermittently cut a moving target web 26 includes a knife roll 32 which has at least one knife member 44 and is rotatable to provide an operative knife-member speed; and an anvil roll 34 which has at least one anvil member 46 and is rotatable to provide an operative anvil-member speed. The anvil roll 34 is positioned to provide an operative nip region 30 between the anvil roll 34 and the knife roll 32. The target web has a substantially continuous and substantially contiguous lengthwise dimension along the machine-direction 22, and an operative web transport mechanism or system 54 moves the target web 26 at a web speed through the nip region. A control system 36 coordinates a rotational positioning of the knife member 44 with a rotational positioning of its cooperating anvil member 46 to provide an operative, cutting engagement between the knife member and its cooperating anvil member to thereby cut the moving web 26 at intermittent locations spaced along a longitudinal, machine-direction 22 of the web. Additionally, the control system 36 can coordinate a speed of the knife member with a speed of its cooperating anvil member to help provide the operative, cutting engagement between the knife member and its cooperating anvil member.

In particular aspects, the knife roll can include a plurality of two or more, and alternatively three or more, knife-members that are spaced apart along an outer circumference of the knife roll. The anvil roll can include a plurality of two or more, and alternatively three or more, anvil-members that are spaced apart along an outer circumference of the anvil roll.

The cutting method and apparatus 20 can thereby form and produce a cut web 26a, and the cut web can include a single cut or a multiplicity of cuts. In a particular aspect, each employed cut can be distributed in a predetermined pattern or array. In another aspect, an individual line or other individual array of perforations which extends along the cross-direction 24 of the web can be produced at predetermined cut locations 38 that are intermittently spaced apart at substantially non-contiguous areas or regions along the machine-direction 22 of the cut web 26a.

In conventional arrangements, the knife roll is generally a moving, rotating roll, and the anvil is generally a stationary component. In the method and apparatus that includes the invention, the terms knife and anvil are employed to indicate that there are two cutting components. Since both the knife and anvil are moving and rotating, and since the relative arrangements of the knife and anvil rolls can be substantially interchangeable, the distinction between the knife and anvil rolls may be less defined. In a particular aspect of distinction, the knife roll has knife members (e.g. knife blades) with nonlinear or notched operating edges, and the anvil roll has anvil members (e.g. anvil blades) with substantially straight operating edges.

By incorporating its various aspects and features, alone or in desired combinations, the method and apparatus can provide better control of the relative speeds at which the cooperating anvil members and knife members contact or otherwise engage each other in the nip region between the knife and anvil rolls. In desired arrangements, the method and apparatus can help provide selected speed differences or differentials between the moving web, the moving knife member and its cooperating, moving anvil member in the nip region to help provide a more reliable and more consistent perforating or other cutting operation. Impact loads between the knife member and its cooperating anvil member can be more efficiently and effectively controlled, and a more consistent yet lower force can be provided between the anvil and knife-members. As a result, the method and apparatus can provide more reliable and consistent cutting, and can require less maintenance. The method and apparatus have a greater process flexibility and versatility. The greater versatility can enable the production of a wider range of products without having to “grade-change” the set-up and arrangement of the production line, and without having to significantly change the movement path of the target web.

It should be readily appreciated that the cutting method and apparatus 20 can be employed in any suitable manufacturing system that includes a high-speed cutting of selected web materials. For example, the method and apparatus can be employed in the construction of sheet materials, facial tissue, bath tissue, wipes, toweling, disposable personal care articles, disposable absorbent articles or the like.

The target web 26 can include one or more selected materials. As representatively shown, for example, the target web can include a single layer or multiple layers. The multiple layers may differ from one another, or may be substantially the same. Optionally, the target web may include a combination of one or more additional webs of material. Any suitable web material may be employed. Such webs can, for example, include woven fabrics, nonwoven fabrics, spunbond fabrics, meltblown fabrics, carded-web fabrics, bonded-carded web fabrics, coform web fabrics, composite fabrics, polymer films, polymer film webs, or the like, as well as combinations thereof. Examples of suitable nonwoven webs can include spunbond (SB) fabrics, spunbond-meltblown-spunbond (SMS) laminates, neck-bonded-laminates (NBL), Point UnBonded (PUB) fabrics, Vertical Filament Laminates (VFL), Stretch Bonded Laminates (SBL), metal or metallic composite foils such as aluminum foil, or the like. The target web 26 may also include other materials, as desired. For example, the desired materials may include cellulosic fibers, absorbent natural fibers, such as woodpulp fibers or cotton fibers, absorbent synthetic fibers, particles or other forms of superabsorbent polymer materials, or the like, as well as combinations thereof. Additionally, the target web can be formed with any operative process. For example, the target web may be airformed, airlaid, dry-laid, wet-laid or combinations thereof.

As representatively shown, the method and apparatus 20 includes a knife roll 32, and an anvil roll 34. The knife roll has at least one knife member 44 and is rotatable to provide an operative knife-member speed; and the anvil roll 34 has at least one anvil member 46, and is rotatable to provide an operative anvil-member speed. The knife roll 32 and the anvil roll 34 are proximally positioned relative to each other to provide an operative nip region 30 between the anvil roll and the knife roll. The target web has a substantially continuous and substantially contiguous lengthwise dimension along the machine-direction 22, and an operative web transport mechanism or system 54 moves the target web 26 at a selected, predetermined web speed through the nip region 30. A control system 36 coordinates a rotational positioning of the knife member 44 with a rotational positioning of its cooperating anvil member 46 to provide an operative, cutting engagement between the knife member and its cooperating anvil member to thereby cut the moving web 26 at intermittent cut locations 38 that are intermittently spaced-apart along the longitudinal, machine-direction 22 of the web.

In the various configurations of the method and apparatus 20, the knife-member speed can be provided approximately along the outer periphery of the knife roll, and the anvil-member speed can be provided approximately along the outer periphery of the anvil roll. Additionally, the control system 36 can include an electronic computer or other electronic data processor. In particular aspects, the cut locations 38 can be intermittently spaced-apart along the longitudinal, machine-direction 22 of the web at substantially regular intervals. Optionally, the cut locations 38 can be intermittently spaced-apart along the longitudinal, machine-direction 22 of the web at irregular intervals.

In desired arrangements, the target web can extend substantially continuously along its longitudinal machine-direction for a distance of at least about 4 m (meters) or more desirably, at least about 10 m. The continuous longitudinal extent of the target web can alternatively be at least about 20 m and can optionally be at least about 30 m to provide desired efficiencies. In other arrangements, the continuous longitudinal extent of the target web can be up to about 20,000 m or more to provide desired operating efficiencies. It is readily apparent that a lowering of the frequency of changing the supply of the target web material can advantageously reduce waste and raise operating efficiencies.

It should be readily appreciated that any operative transport mechanism or system may be employed to move the target web 26 through the method and apparatus 20. Any suitable transport or delivery system or technique may be employed. Conventional systems and mechanisms, such as roller systems, belt systems, pneumatic systems, conveyors and the like, are well known and available from commercial vendors.

The knife roll 32 has an axially extending, rotational shaft member 56, and an operative axis of rotation 40. The anvil roll 34 also has an axially extending, rotational shaft member 58, and an operative axis of rotation 42. In typical arrangements, the rotational axes of the cutting rolls can be substantially parallel to each other. Accordingly, the rotational axis 40 of the knife roll can be substantially parallel to the rotational axis 42 of the anvil roll. The web path 64 of the target web may be aligned perpendicular to the rotational axis of the knife roll and/or the rotational axis of the anvil roll. Accordingly, the cross-direction of the target web 26 may be parallel to the rotational axis of the anvil roll, and/or the rotational axis of the anvil roll. In desired configurations, the web path 64 of the target web may not be aligned perpendicular to the rotational axis of the knife roll or the rotational axis of the anvil roll. Accordingly, the cross-direction of the target web 26 may not be parallel to the rotational axis of the anvil roll, or the rotational axis of the anvil roll, and may have a selected offset angle. The offset angle can be determined from calculations based on the design parameters of the cutting system. For example, the offset angle can depend upon the length of the perforation line along the cross-direction of the target web. In a conventional manner, the offset angle can be configured to provide a desired cutting angle across the cross-directional width of the target web. Desirably, the offset angle can be arranged to provide a cutting angle that is substantially parallel to the cross-direction 24 and generally perpendicular to the machine-direction 22 of the target web.

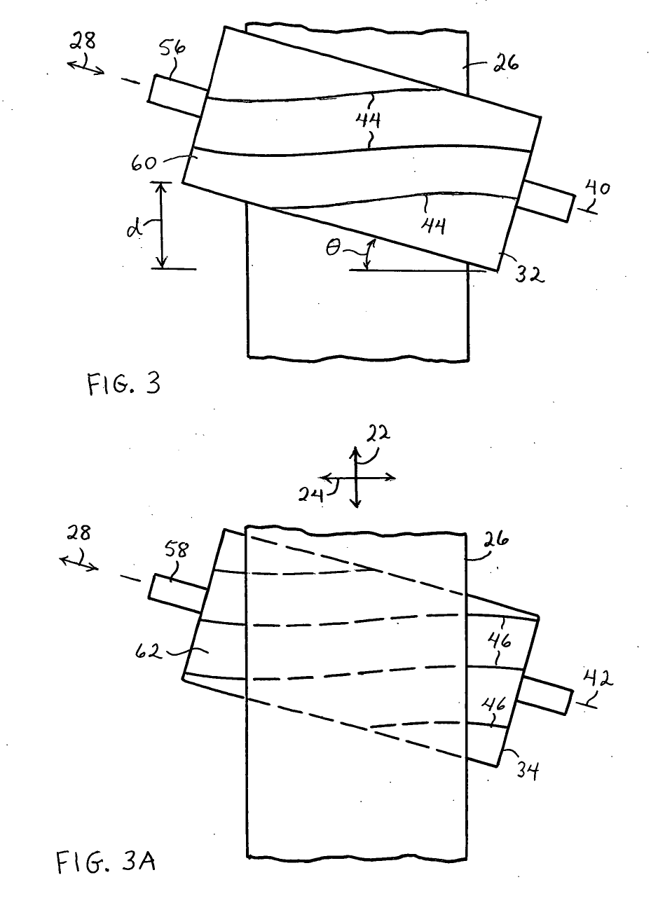

The knife roll 32 has a shaft portion 56, and can be operatively mounted for rotation by employing a suitable support structure in a conventional manner that is well known in the art. The knife roll 32 can have the general form of a cylinder with a substantially circular cross-section, a lengthwise, axial direction 28 (e.g. FIG. 3), a circumferential direction 78 (e.g. FIG. 1) and a radial direction. The knife-members are distributed generally on and about the outer surface of the cylinder. As representatively shown, the knife roll has an outer peripheral surface 60, and can be provided with selected plurality of knife members 44, which may be arrayed or otherwise arranged in any operative distribution along the outer periphery of the knife roll. The individual knife members may have any operative configuration, and any operative array may be employed. The array of knife members may be distributed in a pattern that is regular, irregular, linear, curvilinear, nonlinear, or the like, as well as combinations thereof. Techniques for constructing the individual knife members and the distributed, pattern arrays are conventional and well known in the art. Suitable techniques for operatively mounting and securing the knife-members on the knife roll are also conventional and well known in the art. The pattern of knife members can be configured to have any operative distribution. For example, the pattern may be intermittent (e.g. arranged in two or more discrete segments) along the circumferential-direction of the knife roll. Additionally, the pattern may be intermittent, arranged in two or more discrete segments, or substantially continuous along the axial direction 28 of the knife roll.

The individual knife-members can be irregularly or substantially regularly spaced along circumferential-direction of the knife roll in any desired, operative distribution pattern. Such distributions of knife members are conventional and well known. The individual knife members are operatively secured to the knife roll, and can have any operative, size, shape and/or cross-section. In desired arrangements, the knife-members are detachable, removable and replaceable, with respect to the knife roll. For example, each knife-member can be operatively bolted and/or clamped to the knife roll. Each knife-member can extend radially above the peripheral surface of the knife roll by an operative distance. Each individual knife member, however, may or may not extend parallel to the rotational axis or axial direction of the knife roll. In desired configurations, each knife-member may extend circumferentially and axially in an operative, generally helical path along the outer periphery of the knife roll.

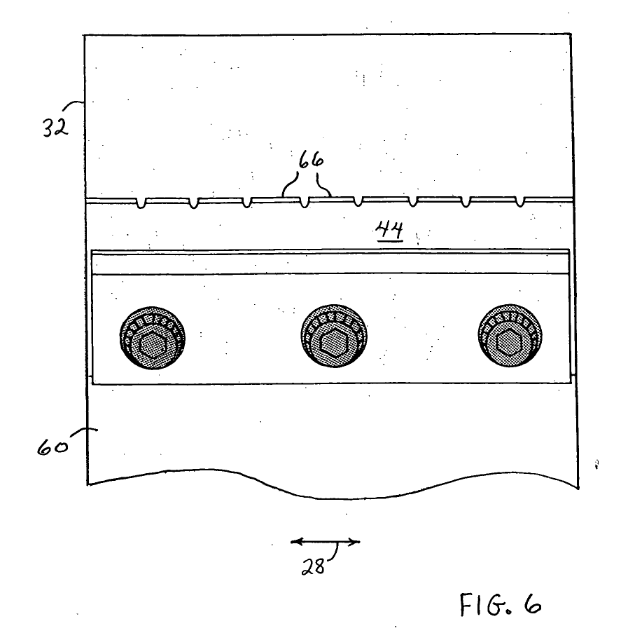

Each knife-member can have a substantially straight or substantially constant-height profile along its generally axial, lengthwise dimension; or can have a contoured profile. The contoured profile of the knife-member may be notched or otherwise configured to provide a series of cutting-teeth elements 66 that are configured to cut the target web with a desired perforation or other cutting pattern 68 (e.g. FIG. 6). The cutting-teeth elements can be intermittently spaced along the generally axial dimension of the knife-member in a desired pattern. The spacing pattern of cutting-teeth elements may be irregular or substantially regular, as desired. The cutting-teeth elements extend radially away from the periphery or peripheral surface of the knife roll, and are intermittently spaced along the generally axial direction/dimension of the knife-member. Any operative pattern of intermittent spacing may be employed, and the intermittent spacing of cutting-teeth elements may be irregular or substantially irregular, as desired. Each perforation pattern can be configured to extend generally along the cross-direction; and a spaced-apart series of perforation patterns can be intermittently located in a regularly or irregularly occurring sequence along the machine-direction of the target web. Since a discrete amount of interference between the knife and anvil members is typically required for reliable, consistent cutting, the knife-members are desirably configured to operatively bend or flex to absorb or otherwise accommodate impact loads that might be encountered during ordinary use.

Suitable knife rolls and knife-members can be produced and configured in a conventional manner, and are available from commercial vendors. For example, suitable knife rolls may be obtained from Paper Converting Machinery Company (PCMC), a business having offices located in Green Bay, Wis. U.S.A.; and from Fabio Perini SpA., a business having offices located in Lucca, Italy. Suitable knife-members may be obtained from The Kinetic Company, a business having offices located in Greendale, Wis., U.S.A.

The anvil roll 34 can have the general form of a cylinder with a substantially circular cross-section, a lengthwise, axial direction 28, a circumferential direction 78 and a radial direction. As representatively shown, the anvil roll 34 can be provided with selected plurality of anvil-members 46, which may be arrayed or otherwise arranged in any operative distribution along the outer periphery of the anvil roll. The individual anvil members can have any operative, size, shape and/or cross-section. The anvil roll has a shaft portion 58, and can be operatively mounted for rotation by employing a suitable support structure in a conventional manner that is well known in the art. The anvil roll can have a plurality of two or more anvil members, and each anvil member can be detachable, removable and replaceable, with respect to the anvil roll. For example, each anvil-member can be operatively bolted and/or clamped to the anvil roll. The individual anvil-members may have any operative configuration, and any operative array may be employed. The array of anvil-members may be distributed in a pattern that is regular, irregular, linear, curvilinear, nonlinear, or the like, as well as combinations thereof. Techniques for constructing the individual anvil-members and the distributed, pattern arrays are conventional and well known in the art. Suitable techniques for operatively mounting and securing the anvil-members on the anvil roll are also conventional and well known in the art. The anvil-members can, for example, be configured to operatively bend or flex to absorb or otherwise accommodate impact loads that might be encountered during ordinary use.

The pattern of anvil-members can be configured to have any operative distribution. The pattern may be intermittent, arranged in two or more discrete segments, along the circumferential-direction of the knife roll. Additionally, the pattern may be intermittent, such as by being arranged in two or more discrete segments, or substantially continuous along the axial direction 28 of the anvil roll. The anvil-members can be irregularly or substantially regularly spaced-apart along the circumferential direction of the anvil roll 34 in any desired, operative distribution pattern. Each anvil-member can extend radially beyond and above the outer peripheral surface 62 of the anvil roll 34 by an operative height distance. In desired arrangements, each individual anvil-member can have a substantially straight or substantially constant-height profile along its lengthwise extent along a generally axial direction 28 of the anvil roll. Each individual anvil member may or may not extend parallel to the rotational axis of the anvil roll; may extend in an operative, generally helical path along the outer periphery of the anvil roll. In the various configurations of the method and apparatus, the number of anvil members 46 on the employed anvil roll 34 may or may not equal number of knife members 44 on the employed knife roll 32.

The anvil roll can have a configuration and construction that is similar to that of the knife roll. Accordingly, suitable anvil rolls and anvil-members can be produced and configured in a conventional manner, and are available from commercial vendors. For example, suitable anvil rolls and anvil-members may be obtained from the Paper Converting Machinery Company (PCMC), a business having offices located in Green Bay, Wis. U.S.A.; and from Fabio Perini SpA, a business having offices located in Lucca, Italy. Suitable anvil-members may also be obtained from The Kinetic Company, a business having offices located in Greendale, Wis., U.S.A.

With reference to FIG. 1, the method and apparatus 20 can further include a knife encoder 70 which has been operatively connected to the knife roll 32; and rotational, knife positioning data has been provided from the knife encoder to an operative electronic computer or control system 36. The knife roll 32 has been rotationally driven with a knife, servo or servo-drive mechanism 72 which is operatively controlled by the computer or other control system 36. Additionally, an anvil encoder 74 has been operatively connected to the anvil roll 34, and rotational, anvil positioning data has been provided from the anvil encoder to the computer or control system 36. The anvil roll 34 has been rotationally driven with an anvil, servo or servo-drive mechanism 76 which is operatively controlled by the computer or control system 36 to thereby coordinate the rotational positioning of the knife member 44 with the rotational positioning of its cooperating anvil member 46 and provide the operative, cutting engagement between the knife member and its cooperating anvil member when the knife-member and anvil-member are moving through the nip region 30. The knife-member and cooperating anvil-member can operatively contact and cut the portion of the target web 26 that is simultaneously moving through the nip region.

As a result, the drive technique or system employed with the method and apparatus 20 can be configured to counter-rotate, and cooperatively phase the cutting rolls 44, 46. In desired arrangements, the computer-controlled, servo-drive systems can operatively synchronize the movements and positions of each knife-member and its cooperating anvil-member during the rotations of the cutting rolls to generate the desired distributions of perforations or other cuts. The relative phasing of a knife-member and its cooperating anvil-member can be controlled in a manner that is conventional and well known in the art.

The knife roll and anvil roll encoders can have a high resolution of at least about 1000 counts per revolution, and can have a resolution of up to about 33000 counts per revolution or 100,000 counts per revolution, or more. Desirably, the encoders can also have a resolution of at least about 2000 counts per revolution, or at least about 4000 counts per revolution to provide improved control of the relative positions of cooperating knife and anvil members.

Suitable servo drive mechanisms and encoder mechanisms for the knife roll and anvil roll are commercially available. For example, a suitable servo drive system can include a Rockwell MPL type servo motor with a multi-turn high resolution encoder, such as provided by Rockwell part number MPL-B68OF-MJ24AA. Rockwell is a business having offices located in Cleveland, Ohio, U.S.A.

Suitable computers, data processing systems, and computerized control systems are conventional and well known, and are available from commercial vendors. For example, a suitable controller system can include a Rockwell CONTROLLOGICS programmable automation controller.

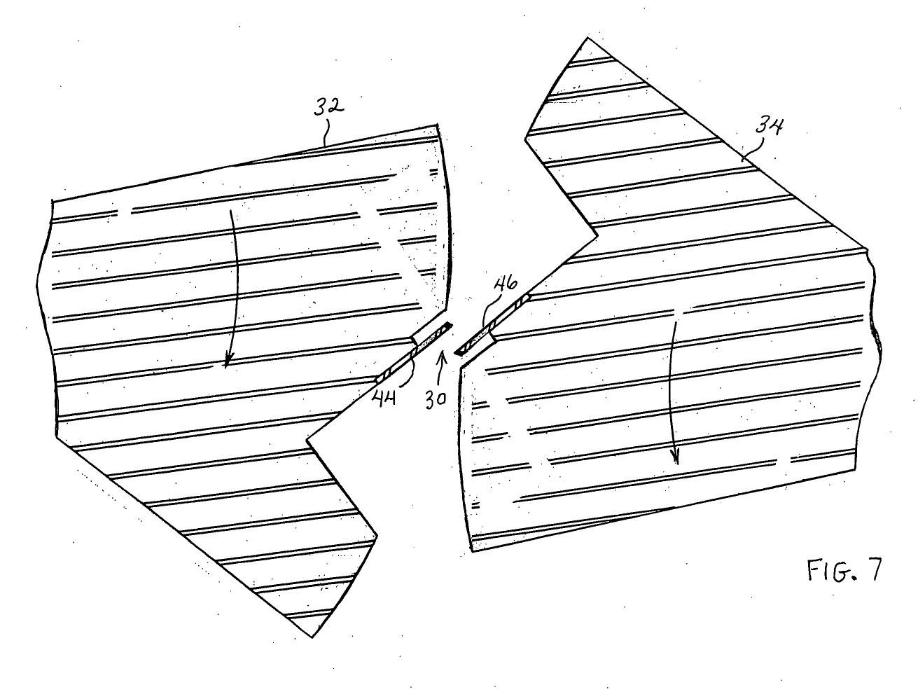

The nip region 30 between the cutting rolls 32, 34 can include a variable nip gap distance or a substantially fixed, nip gap distance. Desirably, the method and apparatus can be configured to provide a selected interference engagement between a knife member and a cooperating anvil member. In a particular aspect, the method and apparatus can be configured to operatively provide and maintain a selected amount of cutting interference or “overlap” distance along the respective radial directions extending between the knife-member 44 and its cooperating anvil-member 46 when the knife-member and its cooperating anvil-member are in the nip region 30 during the rotating of the knife roll and anvil roll (e.g. FIGS. 1 and 7). When properly selected and adjusted, the amount of cutting interference can provide a neat, “clean” perforating or other cutting operation, which is reliably and consistently produced. In a particular feature, the cutting interference distance can be at least a minimum of about 0.1 mm. In other aspects, the interference distance can be up to a maximum of about 0.38 mm, or more. The interference distance can alternatively be up to about 0.25 mm, and can optionally be up to about 0.15 mm to provide desired performance.

The amount or distance of interference occurs when the center-to-center spacing distance 52 between the center of the knife roll 32 and the center of the anvil roll 34 is less than the sum of the knife roll radius 48 and the anvil roll radius 50. The interference amount or distance can be calculated from the knife roll radius 48 (R_{K}), the anvil roll radius 50 (R_{A}), and the center-to-center spacing distance 52 (D): Interference distance=(R_{K})+(R_{A})−(D). For the purposes of the present disclosure, the radius of the knife roll is determined with respect to the radial length measured from the center of the knife roll to the operative, distal edge of its corresponding cutting blade-member (e.g. the radially-outboard edge of the knife-member). The radius of the anvil roll is determined with respect to the radial length measured from the center of the anvil roll to the operative, distal edge of its corresponding cutting blade-member (e.g. the radially-outboard edge of the anvil-member).

With reference to FIGS. 1-5A, the method and apparatus 20 can be configured to provide a knife-member speed, an anvil-member speed, and a target web speed, and the speeds can be operatively coordinated with each other to provide a desired cutting operation. In a particular aspect, the speeds of the knife member 44 and its cooperating anvil member 46 in the nip region 30 have been operatively controlled to provide a predetermined web pitch distance (e.g. Ps) between the cutting lines or other cutting patterns 68 formed at the intermittent locations 38 that have been spaced-apart along the longitudinal, machine-direction 22 of the target web. The knife-member speed and anvil member speed have been operatively controlled to provide a web pitch distance, and in a particular aspect, the web pitch distance can be at least a minimum of about 6 cm. The web pitch distance can alternatively be at least about 7 cm, and can optionally be at least about 8 cm to provide desired benefits. In other aspects, the web pitch distance can be up to a maximum of about 305 cm, or more. The web pitch distance can alternatively be up to about 100 cm, and can optionally be up to about 46 cm to provide desired effectiveness.

With a given set of anvil and knife rolls, the variation in the web pitch distance can be a selected percentage of a nominal value for which the set of anvil and knife rolls have been designed and configured. In a particular aspect, the variation in the web pitch distance can be at least a minimum of about 70% of the nominal pitch distance. The variation in the web pitch distance can alternatively be at least about 75% of the nominal pitch distance, and can optionally be at least about 80% of the nominal pitch distance to provide desired benefits. In other aspects, the variation in the web pitch distance can be up to a maximum of about 130% of the nominal pitch distance. The variation in the web pitch distance can alternatively be up to about 125% of the nominal pitch distance, and can optionally be up to about 120% of the nominal pitch distance to provide desired effectiveness.

Another feature of the method and apparatus 20 can have a configuration in which the computer or other control system 36 has been operatively directed to coordinate the knife-member speed (e.g. V1), the anvil member speed (e.g. V2) and the web speed (e.g. Vs) to thereby modify or change the produced, web pitch distance. In desired configurations the computer can be reprogrammed or otherwise electronically directed to appropriately coordinate the knife-member speed, the anvil member speed, the skew angle of the rolls, and the web speed to provide the desired change in the web pitch distance. Accordingly, the web pitch distance can be changed within a distinctively wide range of variation without physically changing or modifying the structural configuration of the knife roll or anvil roll, e.g. by changing the knife roll to include a greater or lesser number of knife-members or blades. In particular arrangements, the web pitch variation can be at least a minimum of about 7 cm. The web pitch variation can alternatively be at least about 8 cm, and can optionally be at least about 9 cm to provide desired benefits. In other aspects, the web pitch variation can be up to a maximum of about 183 cm, or more. The web pitch variation can alternatively be up to about 150 cm, and can optionally be up to about 104 cm to provide desired effectiveness.

In a further feature, the speed of an individual knife-member can be selectively controlled to provide desired performance. The knife-member speed can be configured to provide a knife-web speed difference or speed differential, and the knife-web speed difference may be configured to be zero or different than zero. The speed of the knife-member can, for example, be a selected percentage of the speed of the target web. In particular aspects, the speed of the knife-member can be at least a minimum of about 70% of the speed of the target web. The knife-member web speed can alternatively be at least about 75% of the target web speed, and can optionally be at least about 80% of the target web speed to provide improved efficiencies. In other aspects, the knife-member speed can be up to a maximum of about 130% of the speed of the target web. The knife-member speed can alternatively be up to about 125%, and can optionally be up to about 120% of the target web speed to provide desired effectiveness. Accordingly, the speed of the knife-member can be plus or minus (±) 30% of the speed of the target web. The knife-member speed can alternatively be ±25% of the speed of the target web, and can optionally be ±20% of the speed of the target web to provide desired benefits.

If the speed of the knife-member is outside the desired values, undesired strains can be imparted to the moving target web. For the purposes of the present disclosure, the knife-member speed is determined substantially at the operative, radially-outboard, distal edge of the knife-member.

Another feature of the method and apparatus can have a configuration in which a speed of an individual anvil-member speed has been selectively controlled to provide desired performance. The knife-member speed and the anvil-member speed can be configured to provide a knife-anvil speed difference or speed differential, and the knife-anvil speed difference may be configured to be zero or different (greater or less) than zero. For example, the speed of the anvil-member can be configured to be a selected percentage of the speed of the cooperating knife-member, and in a particular aspect, the speed of the anvil-member can be at least a minimum of about 75% of the speed of the cooperating knife-member. The anvil-member speed can alternatively be at least about 80% of the cooperating knife-member speed, and can optionally be at least about 90% of the cooperating knife-member speed to provide improved efficiencies. In other aspects, the speed of the anvil-member can be up to a maximum of about 125% of the speed of the cooperating knife-member. The anvil-member speed can alternatively be up to about 120% of the cooperating knife-member speed, and can optionally be up to about 110% of the cooperating knife-member speed to provide desired effectiveness. Accordingly, the speed of the anvil-member can be plus or minus ±25% of the speed of the knife-member. The anvil-member speed can alternatively be ±20% of the speed of the knife-member, and can optionally be ±10% of the speed of the knife-member to provide desired benefits. In desired arrangements, the anvil-member speed can be based on the design parameters of the knife roll, the desired speed differential for perforating the web, and the speed of the web.

If the speed of the anvil-member is outside the desired values, undesired strains can be imparted to the moving target web. For the purposes of the present disclosure, the anvil-member speed is determined substantially at the operative, radially-outboard, distal edge of the anvil-member.

Another feature of the method and apparatus can include a controlled or regulated web speed of the target web. In particular aspects, the web speed of the target web can be at least a minimum of about 50 m/min. The web speed can alternatively be at least about 100 m/min, and can optionally be at least about 150 m/min to provide improved efficiencies. In other aspects, the web speed can be up to a maximum of about 1500 m/min, or more. The web speed can alternatively be up to about 1250 m/min, and can optionally be up to about 1000 m/min to provide improved effectiveness.

Where the anvil roll and knife roll are both rotating, the method and apparatus 20 can better control the relative speed at which the cooperating anvil-members and knife-members contact each other in the nip region. Where the knife-member is moving in the same direction as its cooperating anvil-member in the nip region (e.g. with less speed difference), any impact loads between the knife-member and its cooperating anvil-member can be reduced. As a result, the method and apparatus can be operated with less maintenance and greater reliability. Additionally, the reliability and consistency of the cutting operation can be improved.

In the various configurations of the method and apparatus, the knife-member speed may or may not equal the web speed. Additionally, the anvil-member speed may or may not equal the web speed, and the knife-member speed may or may not equal the anvil-member speed. In desired arrangements, the knife-member speed in the nip region 30 can be along substantially the same direction as that of the anvil-member speed, but may optionally be configured to be in the opposite direction. In the nip region, the anvil-member speed can be along substantially the same direction as the direction of the web speed. Similarly, the knife-member speed can be along substantially same direction as the direction of the web speed.

To help provide desired speed data; e.g. data regarding the knife-member speed, anvil-member speed and/or web speed; the method and apparatus can include operative speed sensors. Such speed sensors are conventional and available from commercial vendors. Suitable speed sensors can, for example, include tachometers, Doppler speed sensors, laser-Doppler speed sensors or the like, as well as combinations thereof.

In other aspects of the method and apparatus, sequentially positioned knife-members and sequentially positioned anvil-members may or may not cooperatively engage with each other in an immediately serial or immediately consecutive fashion. Accordingly, knife-members that are immediately, circumferentially adjacent each other on the knife roll may or may not cooperatively engage with anvil-members that are immediately, circumferentially adjacent each other on the anvil roll. After a first knife-member engages a first anvil-member in the nip region, the knife-member that next-arrives in the nip region (e.g. the next-arriving knife-member) may or may not engage the anvil-member that next-arrives in the nip region (e.g. the next-arriving anvil-member). The next-arriving knife-member may, for example, engage the second-arriving, third-arriving, fourth-arriving or other-arriving anvil-member that operatively enters the cooperative nip region during the rotations of the knife roll and anvil roll. The rotational sequencing of the cutting engagements between knife-members and cooperating anvil-members may be irregular or substantially regular, and can be selected and regulated by employing the computer or other control system 36.

In further aspects, the two rotating perforating rolls or other cutting rolls can operate at different speeds to create lines of perforations or cuts that extend transversely across the web, and are spaced-apart at varying distances along the machine-direction of the web. In addition, several different sets of knife-members or anvil-members can be installed on either or both of the cutting rolls (44, 46), and the cutting rolls can be configured to move out-of-phase to engage desired, cooperating pairs or other cooperating sets of the knife and anvil members. In other aspects, the cutting rolls can be configured to move out-of-phase to operatively avoid engagement between predetermined, selected sets of the knife and anvil members. The various aspects of the roll configurations can provide increased operational flexibility while maintaining substantially the same path of the target web. The method and apparatus 20 do not need to be shutdown to accommodate changes to the knife-members, and maintenance of the cutting rolls can be reduced. Additionally, the knife roll can include knife-members with different cutting patterns installed at selected locations, and the different cutting patterns can be employed during the cutting of a target web. Alternatively, the knife roll can include knife-members with the same cutting pattern installed in all knife-member locations to provide a back-up or replacement set of knife-members when a currently operating set of knife-members needs to be replaced. Similarly, the anvil roll can include “extra” anvil members that can provide a back-up or replacement set of anvil-members when a currently operating set of anvil-members needs to be replaced.

In still other aspects, the rotational speed of the knife roll, the rotational speed of the anvil roll and the web speed can be regulated and operatively coordinated to provide the desired cutting when the method and apparatus is accelerating from a stopped condition to a substantially steady-state operating condition. Similarly, the rotational speed of the knife roll, the rotational speed of the anvil roll and the web speed can be regulated and operatively coordinated to provide the desired cutting when the method and apparatus is decelerating from a substantially steady-state operating condition to a stopped condition. During such ramp-up and/or ramp-down period, the method and apparatus can, for example, provide the desired web pitch spacing distance and the desired cutting alignments (e.g. cut lines that extend transversely and substantially perpendicular to the machine-direction). In particular aspects, the speed of the knife-member, the speed of its cooperating anvil-member, and the speed of the target web can be regulated and operatively coordinated to provide the desired cutting when the method and apparatus are ramping up or ramping down. The distinctive regulation and control of the speeds of the knife-members and anvil-members can help provide improved productivity and a more efficient manufacturing operation.

With reference to FIGS. 4-5A, the method and apparatus 20 can be configured to include the following parameters:
P₁=Pitch distance between sets of blades (e.g. knife-members 44) along the circumference of roll 1 (e.g. knife roll 32).
P₂=Pitch distance between sets of blades (e.g. anvil-members 46) along the circumference of roll 2 (e.g. anvil roll 34).
Pₛ=Pitch distance between perforation lines along the machine-direction of the sheet (e.g. target web).
C₁=Circumference of roll 1 (e.g. as measured at the distal edge of the corresponding knife member).
C₂=Circumference of roll 2 (e.g. as measured at the distal edge of the corresponding anvil member).
n₁=number of cutting blades or blade members (e.g. knife-members 44) on roll 1.
n₂=number of cooperative, cutting blades or blade members (e.g. anvil-members 46) on roll 2.
V₁=Surface speed of roll 1 (e.g. knife-member speed).
V₂=Surface speed of roll 2 (e.g. anvil-member speed).
Vₛ=Surface speed of the sheet (e.g. web speed of target web).
ΔV =Difference is speed between the surface speed of roll 1 and roll 2. A positive value means that V₁is greater than V₂.
L=Width of the sheet, or the perforating length or other cutting length of the roll.
l₁=Lead of roll 1; the length or distance along the circumference of the roll between the location of the two axially-opposed ends of the cutting members on roll 1.
l₂=Lead of roll 2.
A₁=Lead angle of perforating blades or other cutting blades (e.g. knife-members 44) on roll 1.
A₂=Lead angle of perforating blades or other cutting blades (e.g. anvil-members 46) on roll 2.
θ=Angle of skew required to position the set of cutting rolls to achieve a straight line cut (e.g. straight line of perforations) along the cross-direction of the target web.

The cutting system (e.g. bonding or perforating system) includes two cutting rolls, one with knife-members (e.g. perforating blades) and one with anvil-members. As representatively shown, the cutting rolls can have parallel axes, and can be set apart at a distance that is sufficient to provide an operative interference between the perforating blade and its cooperating anvil-member in the nip region between the two rolls. The knife-members and anvil-members are positioned at the extremities of the diameters of the respective knife and anvil rolls. For the purposes of discussing an example, the perforating roll can be called roll 1. The sheet length, or the pitch distance on the sheet between lines of perforations is called Pₛ. The pitch distance between sets of knife blades on the circumference of roll 1 is defined as P₁. The velocity (speed) difference between the surface speed of roll 1 and the web speed is inversely proportional to the pitch on the sheet and roll 1. The pitch distance on roll 2, P₂, can be the same as the pitch distance on roll 1, but if it is not, the surface velocities of the rolls can be configured to be directly proportional to their pitch values. Note that it can be desirable to have a pitch on roll 1 that is different than the pitch on roll 2, and to have a differential speed between the two rolls. It has been found that the differential speed, ΔV, can vary throughout the speed range of the system, but can be an order of magnitude lower than the speed differential provided by a conventional system having a fixed, stationary anvil. Note that at web speeds below the value of the differential speed, an intermittent motion of roll 2 will be required to maintain a straight cut.

If a different sheet length (e.g., Pₛ) is desired, the relative speed of the cutting rolls can be adjusted to provide the desired sheet length. A commensurate adjustment of the skew angle of the perforating station may also be required to maintain a straight line of perforation across the sheet. Typically, the skew angle can be the angle between the movement direction (e.g. machine-direction 22) of the target web, and the alignment direction of the axes of the cutting rolls (e.g. the knife and anvil rolls). It has been discovered that the amount of change in the skew angle can depend only on the change in sheet length after fixing the design of the rolls. Specific equations regarding the design of the perforating rolls or other cutting rolls are set forth in the present disclosure.

Equations

It can be readily determined that the circumference of roll 1, C₁=n₁*P₁. Similarly, it can be readily determined that the circumference of roll 2, C₂=n₂*P₂.

The pitch distance between the individual cut lines (e.g. transversely-extending lines of perforations) on the sheet (e.g. target web) is based on product requirements. The pitch of the first perforating roll or other cutting roll is chosen to be useful for a wide range of products. If the sheet length and pitch of the first perforating roll or other cutting roll are not the same, the speed of the first perforating or other cutting roll is inversely proportional to speed as shown in Equation 1:

$$\frac{{V}_{S}}{{V}_{1}} = \frac{{P}_{1}}{{P}_{S}} Therefore \text{:} {V}_{1} = {V}_{S} \cdot \frac{{P}_{S}}{{P}_{1}} \qquad Equation 1$$

The ratio of speeds between the first and second perforating rolls or other cutting rolls is directly proportional to their spacing or pitch between the set of perforating blades or other cutting blades (e.g. knife-members). See Equation 2.

$$\frac{{V}_{1}}{{V}_{2}} = \frac{{P}_{1}}{{P}_{2}} Therefore \text{:} {V}_{2} = {V}_{1} \cdot \frac{{P}_{2}}{{P}_{1}} \qquad Equation 2$$

A constant speed difference, ΔV, between V₁ and V₂ is desired to get the cutting action between the rolls to create the perforations or other cuts. A constant differential speed is ordinarily defined as a fixed parameter for this invention. Therefore:

V₁=V₂+ΔV and V₂=V₁−ΔV Equation 3

Substituting Equation 3 into Equation 2, and collecting terms yields:

$$Δ V = {V}_{1} \cdot ( \frac{{P}_{1} - {P}_{2}}{{P}_{1}} ) \qquad Equation 4$$

Note that the differential velocity (speed) is not fixed. Instead, the velocity varies with speed, based on the pitch selected for roll 1 and 2. Further substitution of Equation 1 into Equation 4 yields the following relationship between differential velocity and sheet speed:

$$Δ V = {V}_{s} \cdot \frac{{P}_{s} ( {P}_{1} - {P}_{2} )}{{P}_{1}^{2}} \qquad Equation 5$$

### Note that the differential velocity is proportional to the velocity of the sheet and the selection of the design parameters.

Since a spiral pattern is employed to reduce the force of the cutting operation, and since a straight perforation line or cutting line is desired, the axes of the cutting rolls are skewed to achieve these results. Note that the pitch of the sheet, Pₛ, and the pitch of roll 1, P₁, are not necessarily the same and must be accounted for in this calculation. Equation 1 gives the relationship between the pitch of the sheet and the pitch of roll 1. Accordingly:

$${V}_{1} = {V}_{S} \cdot \frac{{P}_{S}}{{P}_{1}} \qquad Equation 1 A$$

The lead of roll 1 is fixed by the design of the axial length of the roll and the angle of the perforating blades or other cutting blades as:

l₁=L·tan(A₁) Equation 6

The parameter, l₁′, is the circumferential distance that roll 1 has to travel to make the perforation line straight, and is equal to lₛ or the length between perforations on the sheet. The time for the roll 1 to travel between the locations of the perforation lines or other cutting lines is then seen to be:

$${t}_{1} = \frac{{l}_{1}}{{V}_{1}} \qquad Equation 7$$

Since lₛ=l₁′, ; then lₛ=t₁·Vₛ=l₁′. As a corollary to Equation 6 it can be seen that:

L·tan(A₁+θ)=Vₛ·t₁ Equation 8

Substituting Equation 7 into Equation 8 gives:

$$L \cdot tan ( {A}_{1} + θ ) = \frac{{V}_{s} \cdot {l}_{1}}{{V}_{1}}$$

### Collecting terms and solving for θ gives:

$$θ = arc tan ( \frac{{V}_{s} \cdot {l}_{1}}{{V}_{1} \cdot L} ) - {A}_{1} \qquad Equation 9$$

Note that θ is the angle at which the perforating stand or other cutting stand needs to be adjusted to provide a straight perforating or other cutting line across the sheet. In typical arrangements, the axes of the cutting rolls have been aligned with this skew angle. The angle is determined, based on the design of the perforating or other cutting rolls and the required perforating or other cutting length independent of speed as the ratio of Vₛ to V₁ is constant. It is possible to substitute the pitch instead of velocities, as shown in Equation 10.

$$θ = arc tan ( \frac{{P}_{s} \cdot {l}_{1}}{{P}_{1} \cdot L} ) - {A}_{1} \qquad Equation 10$$

At this point, the sheet cutting lines (e.g. lines of perforations) have been adjusted to make a substantially straight line, based on the required cutting length (e.g. perforation length) of the sheet and the design of roll 1. The next section shows that the design of roll 2 depends on the design or roll 1. Note that the time between perforations between roll 1 and roll 2 must be the same. Therefore:

$${t}_{1} = \frac{{l}_{1}}{{V}_{1}} and {t}_{2} = \frac{{l}_{2}}{{V}_{2}} \\ Therefore \text{:} \frac{{l}_{1}}{{V}_{1}} = \frac{{l}_{2}}{{V}_{2}} \qquad Equation 11$$

Substituting Equation 2 into Equation 11 gives

$$\frac{{l}_{1}}{{V}_{1}} = \frac{{l}_{2}}{( {V}_{1} \frac{{P}_{2}}{{P}_{1}} )} ; or \frac{{l}_{2}}{{l}_{1}} = \frac{{P}_{2}}{{P}_{1}} \qquad$$

From Equation 6, it can be seen that:

$$\frac{L \cdot tan ( {A}_{1} )}{L \cdot tan ( {A}_{2} )} = \frac{{P}_{2}}{{P}_{1}} \\ Therefore \text{:} \\ {A}_{2} = arc tan ( \frac{{P}_{2}}{{P}_{1}} \cdot tan ( {A}_{1} ) ) \qquad Equation 12$$

Equation 12 shows that the design of roll 2 is established by the design of roll 1. That is, the pitch and lead values of roll 1 determine the pitch and lead values of roll 2. Additionally, it is noted that these last equations are independent of speed.

In the various configurations of the method and apparatus 20, the knife roll can also be provided with any operative knife-roll diameter and can be constructed with any operative materials. Similarly, the anvil roll can also be provided with any operative anvil-roll diameter and can be constructed with any operative materials. The knife roll diameter may or may not be equal to the anvil roll diameter. In particular aspects, the roll diameters can be at least a minimum of about 10 cm. The roll diameters can alternatively be at least about 15 cm, and can optionally be at least about 20 cm to provide desired benefits. In other aspects, the roll diameters can be up to a maximum of about 150 cm, or more. The roll diameters can alternatively be up to about 140 cm, and can optionally be up to about 130 cm to provide desired effectiveness. For the purposes of the present disclosure, the diameter and circumference of the knife roll or anvil roll are determined with respect to the radial length measured from the center of the roll to the operative, distal edge of its corresponding cutting blade-member (e.g. the radially-outboard edge of the knife-member or anvil-member).

The method and apparatus 20 may have various alternative configurations. The different options are summarized in the following Table 1. In Table 1, all rotations and directions are determined in the nip region at the contact point with the moving target web sheet 26. The diameter and circumference of a roll are determined with respect to a radius (e.g. 48, 50) measured from the center of the roll to the distal edge of an operative cutting blade (e.g. radially-outboard edge of an operative knife-member or anvil-member).

TABLE 1

| Item | Option 1 | Option 2 | Option 3 | Selection and Reason |
|---|---|---|---|---|
| P1 relative to Ps | P1 > Ps | P1 = Ps | P1 < Ps | All options are acceptable |
| | | | | since the sheet tension is |
| | | | | controlled by infeed and |
| | | | | outfeed draw rolls. |
| P1 relative to P2 | P1 > P2 | P1 = P2 | P1 < P2 | All options are acceptable. |
| Rotation direction | Same as | Opposite | | Same direction as sheet to |
| of Roll 1 (R1) in | sheet | to sheet | | limit differential speed. |
| nip region | | | | |
| Rotation direction | Same as | Opposite | Fixed, non- | Same direction as R1 to limit |
| of Roll 2 (R2) in | R1 | to R1 | rotating | differential speed. |
| nip region | | | | |
| Circumference of | Less than | | | 32,727 count encoder gives |
| R1 | 50 inch | | | 0.0015 inch resolution at |
| | | | | 50 inch circumference. 50 inch |
| | | | | circumference →15.92 inch |
| | | | | diameter. |
| Number of cutting | Even | Odd | | Both options are workable. |
| members on R1 | number | number | | |
| Circumference of | Less than | | | 32,727 count encoder gives |
| R2 | 50 inch | | | 0.0015 inch resolution at |
| | | | | 50 inch circumference. 50 inch |
| | | | | circumference →15.92 inch |
| | | | | diameter. |
| Number of cutting | Even | Odd | | Both options are workable |
| members on R1 | number | number | | |
| Number of cutting | Same as | Different | | Both options are workable. It |
| members on R2 | cuts for | from cuts, | | may be desirable to have R2 |
| | R1 | R1 | | make odd-cuts if R1 makes |
| | | | | even-cuts, or vice-versa, to |
| | | | | spread wear. |
| Roll diameter of | Diameter: | Diameter: | Diameter: | Defined by circumference and |
| R1 relative to R2 | R1 > R2 | R1 = R2 | R1 < R2 | cuts for each Roll, and by the |
| | | | | sheet length range desired. |
| | | | | Blades can be skipped for |
| | | | | longer sheet lengths between |
| | | | | perforation patterns. |
| Lead angle of R1, | | | | Typically 2.5°. |
| A1 | | | | |
| Lead angle of R2, | | | | A2 is determined by P2, P1 |
| A2 | | | | and A1 |
| Lead angle | Same as | Opposite | | Both are workable. |
| direction of R2 | lead of R1 | lead of R1 | | |
| Direction of angle | Same | Opposite | | Depends on design and Ps. |
| from axial center- | direction | to l₁ | | |
| line of roll to | as l₁ | | | |
| cross-direction of | | | | |
| sheet. | | | | |

Where:
1 inch = 2.54 cm

The following Examples describe particular configurations of the invention, and are presented to provide a more detailed understanding of the invention. The Examples are not intended to limit the scope of the present invention in any way. From a complete consideration of the entire disclosure, other arrangements within the scope of the claims will be readily apparent to one skilled in the art.

The parameters for Examples 1 and 2 are summarized in the following Tables 2 and 2A.

TABLE 2

| | Example 1 | | Example 2 | |
|---|---|---|---|---|
| Sheet length desired, Ps | 4.09 | inch | 11.25 | inch |
| Speed basis for design | 2000 | ft/min | 2000 | ft/min |
| Differential basis for design, ΔV. | 400 | ft/min | 100 | ft/min |
| Roll 1 - Knife Roll | | | | |
| Roll 1 Number of cuts, n₁ | 12 | | 12 | |
| Roll 1 Blade spacing, P1 | 3 | inch | 9 | inch |
| Roll 1 Circumference | 36 | inch | 36 | inch |
| Roll 1 Diameter | 11.46 | inch | 11.5 | inch |
| Roll 1 Surface speed, V₁ | 1467 | ft/min | 1600 | ft/min |
| Roll 1 Lead angle, A1 | 2.5 | degrees | 2.5 | degrees |
| Roll 1 Length, axial, L₁ | 100 | inch | 100 | inch |
| Roll 1 Lead, l₁ | 4.37 | inch | 4.37 | inch |
| Roll 1 Angle, θ | 2.5 | degrees | 2.5 | degrees |
| Roll 2 - Anvil Roll | | | | |
| Roll 2 Number of cuts, n₂ | 12 | | 4 | |
| Roll 2 Blade spacing, P2 | 2.4 | inch | 7.2 | inch |
| Roll 2 Circumference | 28.8 | inch | 28.8 | inch |
| Roll 2 Diameter | 9.17 | inch | 9.17 | inch |
| Roll 2 Surface speed, V₂ | 1600 | ft/min | 1600 | ft/min |
| Roll 2 Lead angle, A2 | 3.12 | degrees | 3.12 | degrees |
| Roll 2 Length, axial, L₂ | 100 | inch | 100 | inch |
| Roll 2 Lead, l₂ | 5.46 | inch | 5.46 | inch |
| Roll 2 Angle, θ | 2.5 | degrees | 2.5 | degrees |
| Skew distance, d (e.g. FIG. 3) | 3.28 | inch | 2.12 | inch |
| Skew amount due to helix angle | 4.37 | inch | 4.37 | inch |
| Skew amount due to roll vs. web speed | −1.09 | inch | −2.25 | inch |

Where:
1 inch = 2.5 cm;
1 ft/min = 0.305 m/min.

TABLE 2A

| | Web | Speed | Speed | Differential |
|---|---|---|---|---|
| | speed | Roll 1 | Roll 2 | Roll 2 |
| | (ft/min) | (ft/min) | (ft/min) | (ft/min) |
| Example 1 | 25 | 24 | 20 | 5 |
| | 75 | 73 | 59 | 15 |
| | 100 | 98 | 78 | 20 |
| | 200 | 196 | 156 | 39 |
| | 300 | 293 | 235 | 59 |
| | 400 | 391 | 313 | 78 |
| | 500 | 489 | 391 | 98 |
| | 600 | 587 | 469 | 117 |
| | 700 | 685 | 548 | 137 |
| | 800 | 782 | 626 | 156 |
| | 900 | 880 | 704 | 176 |
| | 1000 | 978 | 782 | 196 |
| | 1100 | 1076 | 861 | 215 |
| | 1200 | 1174 | 939 | 235 |
| | 1300 | 1271 | 1017 | 254 |
| | 1400 | 1369 | 1095 | 274 |
| | 1500 | 1467 | 1174 | 293 |
| | 1600 | 1565 | 1252 | 313 |
| | 1700 | 1663 | 1330 | 333 |
| | 1800 | 1760 | 1408 | 352 |
| | 1900 | 1858 | 1487 | 372 |
| | 2000 | 1956 | 1565 | 391 |
| Example 2 | 25 | 27 | 21 | 5 |
| | 75 | 80 | 64 | 16 |
| | 100 | 107 | 85 | 21 |
| | 200 | 213 | 171 | 43 |
| | 300 | 320 | 256 | 64 |
| | 400 | 427 | 341 | 85 |
| | 500 | 533 | 427 | 107 |
| | 600 | 640 | 512 | 128 |
| | 700 | 747 | 597 | 149 |
| | 800 | 853 | 683 | 171 |
| | 900 | 960 | 768 | 192 |
| | 1000 | 1067 | 853 | 213 |
| | 1100 | 1173 | 939 | 235 |
| | 1200 | 1280 | 1024 | 256 |
| | 1300 | 1387 | 1109 | 277 |
| | 1400 | 1493 | 1195 | 299 |
| | 1500 | 1600 | 1280 | 320 |
| | 1600 | 1707 | 1365 | 341 |
| | 1700 | 1813 | 1451 | 363 |
| | 1800 | 1920 | 1536 | 384 |
| | 1900 | 2027 | 1621 | 405 |
| | 2000 | 2133 | 1707 | 427 |

Where:
1 inch = 2.5 cm;
1 ft/min = 0.305 m/min.
Discrepancies in calculations arise due to rounding of individual values.

For the present disclosure, particular parameters can be selected and calculated in the manner summarized in the following Tables 3 and 3A.

TABLE 3
For Roll 1:

| | |
|---|---|
| Select the circumferential spacing (Ps) | |
| between the patterns (e.g. lines) of | |
| perforations desired for the product. | |
| Select number, n₁, of perforation blades | Calculate roll 1 circumference |
| (e.g. knife-members) on the circumference | and diameter. |
| of Roll 1. | |
| Select a speed basis and desired | |
| differential speed, ΔV. | |
| Select a lead angle, A1, for Roll 1 to have | Calculate the lead, l₁ of roll 1. |
| one point of cutting contact which | |
| operatively traverses across the roll face. | |

TABLE 3A
For Roll 2:

| | |
|---|---|
| Select number, n₂ , of perforation | Calculate blade circumferential |
| blades (e.g. anvil-members) on the | spacing for roll 2. |
| circumference of Roll 2. | |
| | Calculate the circumference and |
| | diameter of Roll 2, based on blade |
| | spacing, P2, and number of blades, |
| | n₂, of Roll 2. |
| | Calculate lead angle, A2, of Roll 2, |
| | based on operating speed minus |
| | speed differential, and on blade |
| | spacing, P2. |

Those skilled in the art will recognize that the present invention is capable of many modifications and variations without departing from the scope thereof. Accordingly, the detailed description and examples set forth above are meant to be illustrative only and are not intended to limit, in any manner, the scope of the invention as set forth in the appended claims.

1. A method for intermittently cutting a moving target web, comprising:
rotating a knife roll having at least one knife member to provide an operative knife-member speed;
rotating an anvil roll having at least one anvil member to provide an operative anvil-member speed;
positioning the knife roll and anvil roll to provide an operative nip region therebetween;
moving a substantially continuous target web at a web speed through the nip region;
coordinating a rotational positioning of the knife member with a rotational positioning of its cooperating anvil member to provide an operative, cutting engagement between the knife member and its cooperating anvil member to thereby cut the moving web at cut locations which are intermittently spaced along a machine-direction of the web.

2. A method as recited in claim 1, wherein
a knife encoder has been operatively connected to the knife roll;
rotational, knife positioning data has been provided from the knife encoder to an operative electronic computer;
the knife roll has been rotationally driven with a knife servo mechanism which is operatively controlled by the computer;
an anvil encoder has been operatively connected to the anvil roll;
rotational, anvil positioning data has been provided from the anvil encoder to the computer;
the anvil roll has been rotationally driven with an anvil servo mechanism which is operatively controlled by the computer; to thereby coordinate the rotational positioning of the knife member with the rotational positioning of its cooperating anvil member and provide the operative, cutting engagement between the knife member and its cooperating anvil member.

3. A method as recited in claim 1, wherein a selected amount of cutting interference has been provided between the knife member and its cooperating anvil member in the nip region during the rotating of the knife roll and anvil roll.

4. A method as recited in claim 3, wherein a cutting interference of at least about 0.1 mm has been provided.

5. A method as recited in claim 1, wherein the knife-member speed and anvil member speed have been operatively controlled to provide a predetermined web pitch distance between cutting lines formed at the intermittent locations spaced along the longitudinal, machine-direction of the web.

6. A method as recited in claim 5, wherein the knife-member speed and anvil member speed have been operatively controlled to provide a web pitch distance which is at least about 7 cm.

7. A method as recited in claim 5, wherein a computer has been operatively directed to coordinate the knife-member speed, the anvil member speed and the web speed to thereby change the web pitch distance.

8. A method as recited in claim 7, wherein the knife-member speed is at least about 70% of the web speed of the target web.

9. A method as recited in claim 8, wherein the knife-member speed is up to about 130% of the web speed of the target web.

10. A method as recited in claim 8, wherein the anvil-member speed is at least about 70% of the knife-member speed.

11. A method as recited in claim 10, wherein the anvil-member speed is up to about 130% of the knife-member speed.

12. A method as recited in claim 11, wherein the web speed is at least about 50 m/min.

13. A method for intermittently cutting a moving target web, comprising:
rotating a knife roll having at least one knife member to provide an operative knife-member speed;
rotating an anvil roll having at least one anvil member to provide an operative anvil-member speed;
positioning the knife roll and anvil roll to provide an operative nip region therebetween;
moving a substantially continuous target web at a web speed through the nip region;
coordinating a rotational positioning of the knife member with a rotational positioning of its cooperating anvil member to provide an operative, cutting engagement between the knife member and its cooperating anvil member to thereby cut the moving web at cut locations which are intermittently spaced along a machine-direction of the web;
wherein
a knife encoder has been operatively connected to the knife roll;
rotational, knife positioning data has been provided from the knife encoder to an operative electronic computer;
the knife roll has been rotationally driven with a knife servo mechanism which is operatively controlled by the computer;
an anvil encoder has been operatively connected to the anvil roll;
rotational, anvil positioning data has been provided from the anvil encoder to the computer;
the knife roll has been rotationally driven with an anvil servo mechanism which is operatively controlled by the computer; to thereby coordinate the rotational positioning of the knife member with the rotational positioning of its cooperating anvil member and provide the operative, cutting engagement between the knife member and its cooperating anvil member;
a selected amount of cutting interference has been provided between the knife member and its cooperating anvil member in the nip region during the rotating of the knife roll and anvil roll;
the cutting interference has been maintained at a value of about at least about 0.1 mm;
the web speed is at least about 100 m/min;
the knife-member speed is at least about 70% of the web speed of the target web; and
the anvil-member speed is at least about 70% of the knife-member speed.

14. An apparatus for intermittently cutting a moving target web, comprising:
a knife roll which has at least one knife member and is rotatable to provide an operative knife-member speed;
an anvil roll which has at least one anvil member and is rotatable to provide an operative anvil-member speed, the anvil roll positioned to provide an operative nip region between the anvil roll and the knife roll;
a transport system which moves a substantially continuous target web at a web speed through the nip region;
a control system which coordinates a rotational positioning of the knife member with a rotational positioning of its cooperating anvil member to provide an operative, cutting engagement between the knife member and its cooperating anvil member to thereby cut the moving web at intermittent locations spaced along a longitudinal, machine-direction of the web.

15. An apparatus as recited in claim 14, wherein
a knife encoder has been operatively connected to the knife roll to provide
rotational, knife positioning data from the knife encoder to an operative electronic computer;
a knife servo mechanism is operatively controlled by the computer and rotationally drives the knife roll;
an anvil encoder has been operatively connected to the anvil roll to provide rotational, anvil positioning data from the anvil encoder to the computer; and
an anvil servo mechanism is operatively controlled by the computer to rotationally drive the anvil roll; to thereby coordinate the rotational positioning of the knife member with the rotational positioning of its cooperating anvil member and provide the operative, cutting engagement between the knife member and its cooperating anvil member.

16. An apparatus as recited in claim 14, wherein the knife member and its cooperating anvil member are arranged to provide a selected amount of cutting interference between in the nip region during the rotating of the knife roll and anvil roll.

17. An apparatus as recited in claim 14, wherein the knife-member speed and anvil member speed are operatively controlled to provide a predetermined web pitch distance between cutting lines formed at the intermittent locations spaced along the longitudinal, machine-direction of the web.

18. An apparatus as recited in claim 14, wherein the computer can be operatively directed to coordinate the knife-member speed, the anvil member speed and the web speed to thereby change the web pitch distance.

19. An apparatus as recited in claim 14, wherein the anvil-member speed is at least about 70% of the knife-member speed.

20. An apparatus as recited in claim 14, further including
a knife encoder which has been operatively connected to the knife roll, and provides rotational, knife positioning data to an operative electronic computer;
a knife servo mechanism which is operatively controlled by the computer, and rotationally drives the knife roll;
an anvil encoder has been operatively connected to the anvil roll, and provides rotational, anvil positioning data to the computer;
an anvil servo mechanism which is operatively controlled by the computer, and rotationally drives the anvil roll; to thereby coordinate the rotational positioning of the knife member with the rotational positioning of its cooperating anvil member and provide the operative, cutting engagement between the knife member and its cooperating anvil member.
a selected amount of cutting interference has been provided between the knife member and its cooperating anvil member in the nip region during the rotating of the knife roll and anvil roll;
wherein
the cutting interference has been maintained at a value of at least about 0.1 mm;
the web speed has been configured to be at least about 100 m/min;
the knife-member speed has been configured to be at least about 70% of the web speed; and
the anvil-member speed has been configured to be at least about 70% of the knife-member speed.
